(19) United States
(12) Patent Application Publication
(10) Pub. No.: US 2024/0242243 A1
(43) Pub. Date: Jul. 18, 2024

(54) VALUE DETERMINATION DEVICE BASED ON USER MENTAL STATE, VALUE DETERMINATION METHOD BASED ON USER MENTAL STATE, AND STORAGE MEDIUM

(71) Applicant: NEC Corporation, Minato-ku, Tokyo (JP)

(72) Inventors: Terumi Umematus, Tokyo (JP); Masanori Tsujikawa, Tokyo (JP)

(73) Assignee: NEC Corporation, Minato-ku, Tokyo (JP)

(21) Appl. No.: 18/562,415

(22) PCT Filed: May 26, 2021
(86) PCT No.: PCT/JP2021/019992

§ 371 Date: Nov. 20, 2023

(51) Int. Cl. G06Q 30/0207; G06Q 30/0283

(52) U.S. Cl. CPC G06Q 30/0224; G06Q 30/0283

(57) ABSTRACT

The value determination device 1X mainly includes a mental state acquisition means 16X and a value determination means 17X. The mental state acquisition means 16X is configured to acquire an estimation result of a mental state of a target person. The value determination means 17X is configured to determine a value for goods or a service provided to the target person, based on the estimation result of the mental state.

### TECHNICAL FIELD

The present disclosure relates to the technical field of a price determination device, price determination method, and storage medium for determining a price of goods or a service.

### BACKGROUND

As price setting methods for goods or a service, there are a cost basis method, a competition basis method, and a value basis method. Further, Patent Literature 1 discloses a price determination method in which the user's emotion is predicted from the user's behavior and the prediction result is reflected in the price of goods on a commodity page. In addition, Non-Patent Literature 1 to Non-Patent Literature 3 disclose methods of estimating a mental state.

### CITATION LIST

### Patent Literature

Patent Literature 1: JP 2020-177498A

### Non-Patent Literature

Non-Patent Literature 1: Terumi Umematsu, Akane Sano, Sara Taylor, Masanori Tsujikawa, and Rosalind Picard, “Forecasting stress, mood, and health from daytime physiology in office workers and students,” Proceedings of the 42nd Annual International Conference of the IEEE Engineering in Medicine and Biology Society (EMBC), p. 5953-5957, July 2020.
Non-Patent Literature 2: Terumi Umematsu, Akane Sano., and Rosalind Picard, “Daytime Data and LSTM can Forecast Tomorrow's Stress, Health, and Happiness,” Proceedings of the 41st International Conference of the IEEE Engineering in Medicine and Biology Society (EMBC), p. 2186-2190, July 2019.
Non-Patent Literature 3: Terumi Umematsu, Akane Sano, Sara Taylor, and Rosalind Picard, “Improving Students' Daily Life Stress Forecasting using LSTM Neural Networks.” IEEE International Conference on Biomedical and Health Informatics (BHI), pp. 1-4, May 2019.

### SUMMARY

### Problem to be Solved

Such a price setting method as a cost basis method, a competition basis method, and a value basis method cannot timely reflect subjective elements of a customer of goods or a service in the price while being able to objectively determine the value of the goods or the service.

In view of the above-described issue, it is therefore an example object of the present disclosure to provide a price determination device, a price determination method, and a storage medium capable of suitably determining a price relating to goods or a service.

### Means for Solving the Problem

In one mode of the price determination device, there is provided a price determination device including:
a mental state acquisition means configured to acquire an estimation result of a mental state of a target person; and
a price determination means configured to determine a price for goods or a service provided to the target person, based on the estimation result of the mental state.

In another mode of the price determination device, there is provided a price determination device including:
a mental state acquisition means configured to acquire estimation results of mental states of plural target person; and
a price determination means configured to determine a price for goods or a service provided to the plural target persons, based on the estimation results of the mental states.

In one mode of the price determination method, there is provided a price determination method executed by a computer, the price determination method including:
acquiring an estimation result of a mental state of a target person; and
determining a price for goods or a service provided to the target person, based on the estimation result of the mental state.

In another mode of the price determination method, there is provided a price determination method executed by a computer, the price determination method including: acquiring estimation results of mental states of plural target person; and determining a price for goods or a service provided to the plural target persons, based on the estimation results of the mental states.

In one mode of the storage medium, there is provided a storage medium storing a program executed by a computer, the program causing the computer to:
acquire an estimation result of a mental state of a target person; and
determine a price for goods or a service provided to the target person, based on the estimation result of the mental state.

In another mode of the storage medium, there is provided a storage medium storing a program executed by a computer, the program causing the computer to:
acquire estimation results of mental states of plural target person; and
determine a price for goods or a service provided to the plural target persons, based on the estimation results of the mental states.

### Effect

An example advantage according to the present invention is to suitably determine a price relating to goods or a service.

### BRIEF DESCRIPTION OF THE DRAWINGS

FIG. 1 It shows a schematic configuration of a price determination system according to a first example embodiment.

FIG. 2 It shows an example of a hardware configuration of a price determination device common to each example embodiment.

FIG. 3 It is an example of a functional block diagram of the price determination device according to the first example embodiment.

FIG. 4 It is a diagram showing an outline of the price determination method according to the “fund splitting model”.

FIG. 5A shows the transition of the price in the first mode of the “whole consensus based price variation model”.

FIG. 5B shows the transition of the price in the second mode of the “whole consensus based price variation model”.

FIG. 6A shows the transition of the price in the first mode of the “individual agreement based price variation model”.

FIG. 6B shows the transition of the price in the second mode of the “individual agreement based price variation model”.

FIG. 7 It shows an example of a flowchart executed by the price determination device in the first example embodiment.

FIG. 8 It shows a schematic configuration of a price determination system in a second example embodiment.

FIG. 9 It is a block diagram of a price determination device in a third example embodiment.

FIG. 10 It shows an example of a flowchart executed by the price determination device in the third example embodiment.

### EXAMPLE EMBODIMENTS

Hereinafter, example embodiments of a price determination device, a price determination method, and a storage medium will be described with reference to the drawings.

### First Example Embodiment

### (1) System Configuration

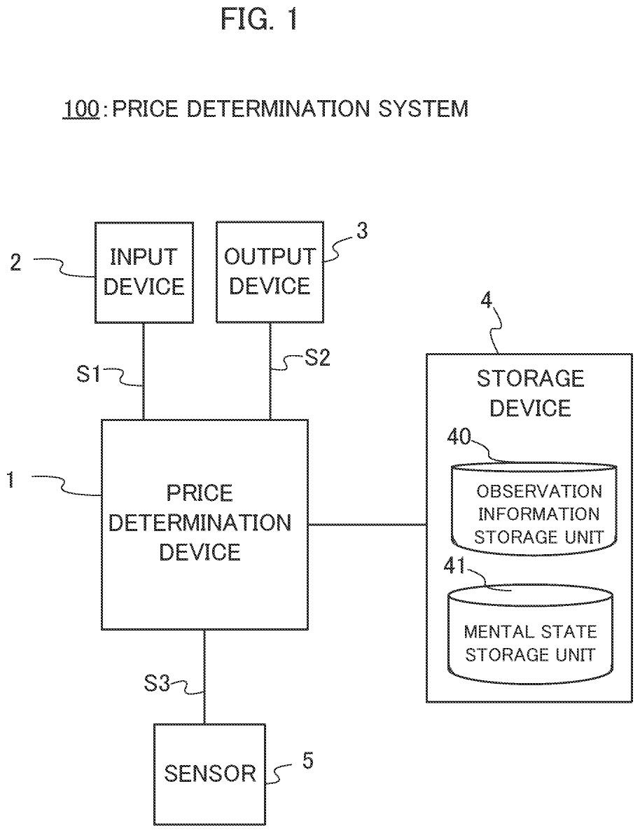

FIG. 1 shows a schematic configuration of a price determination system 100 according to the first example embodiment. The price determination system 100 determines the price for goods or a service based on the mental state of a person (also referred to as “target person”) who is provided with or was provided with the goods or the service. The term “price” herein is not limited to the amount of actually paid money, and at least a part thereof may be substituted by a point, a virtual currency or a discount ticket.

The price determination system 100 mainly includes a price determination device 1, an input device 2, an output device 3, a storage device 4, and a sensor 5.

The price determination device 1 estimates the mental state of the target person and determines the price relating to goods or a service based on the estimation result of the mental state. In this case, the “price relating to goods or a service” may be the amount of money to be paid by the target person who was provide with the goods or the service or may be the amount of remuneration to a remuneration recipient who is supposed to receive the remuneration regarding the service provided to the target person.

The price determination device 1 performs data communication with the input device 2, the output device 3, and the sensor 5 through a communication network or through wireless or wired direct communication. For example, the price determination device 1 receives an input signal “S1” supplied from the input device 2, a sensor signal “S3” supplied from the sensor 5, and various information stored in the storage device 4. The input signal S1 and the sensor signal S3 are used to generate information (also referred to as “observation information”) obtained by subjectively or objectively observing (measuring) the target person.

The input device 2 is one or more interfaces that receive a user input (manual input) of information regarding each target person. The user who inputs the information using the input device 2 may be the target person itself, or may be a person who manages or supervises the activity of the target person. The input device 2 may be a variety of user input interfaces such as, for example, a touch panel, a button, a keyboard, a mouse, and a voice input device. The input device 2 supplies the generated input signal S1 to the price determination device 1. The output device 3 displays or outputs predetermined information based on the output signal S2 supplied from the price determination device 1. Examples of the output device 3 include a display, a virtual (augmented) real terminal, a projector, and a speaker.

The sensor 5 measures a biological signal regarding the target person and supplies the measured biological signal to the price determination device 1 as a sensor signal S3. In this instance, the sensor signal S3 may be any biological signal (including vital information) regarding the target person such as a heart rate, EEG, pulse wave, sweating volume (skin electrical activity), amount of hormonal secretion, cerebral blood flow, blood pressure, body temperature, myoelectric potential, respiration rate, and acceleration. The sensor 5 may also be a device that analyzes blood collected from the target person and outputs a sensor signal S3 indicative of the analysis result. Examples of the sensor 5 include a wearable terminal worn by the target person, a camera for photographing the target person, a microphone for generating a voice signal of the target person's utterance, and a terminal such as a personal computer or a smartphone operated by the target person. For example, the above-described wearable terminal includes a GNSS (global navigation satellite system) recipient, an acceleration sensor, a sensor for detecting biological signals, and the like, and outputs the output signals from each sensor as a sensor signal S3. The sensor 5 may supply information corresponding to the manipulation amount signal from a personal computer or a smartphone to the price determination device 1 as the sensor signal S3. The sensor may also output a sensor signal S3 representing biomedical data (including sleep time) regarding the target person during the sleep.

The storage device 4 is one or more memories for storing various kinds of information necessary for the price determination process executed by the price determination device 1. The storage device 4 may be an external storage device, such as a hard disk, connected to or embedded in the price determination device 1, or may be a storage medium, such as a flash memory. The storage device 4 may be a server device that performs data communication with the price determination device 1. Further, the storage device 4 may be configured by a plurality of devices.

Further, the storage device 4 functionally includes an observation information storage unit 40, and a mental state storage unit 41.

The observation information storage unit 40 stores observation information that is subjective information regarding the target person based on the input signal S1 or objective information regarding the target person based on the sensor signal S3. Here, the sensor signal S3 as it is may be used as the observation information, or features (which includes a value of an index representing a facial expression or emotion analyzed from an image or audio data) calculated based on the sensor signal S3 may be used as the observation information. Further, the observation information may include questionnaire result information generated based on the input signal S1 or a diagnostic result regarding a personality or the like based on the questionnaire result information. For example, the observation information is stored in the observation information storage unit 40 in association with the identification information (target person ID) of the target subject to be observed and the observed date and time information.

The mental state storage unit 41 stores the estimation result of the mental state of the target person estimated from the observation information. Examples of the estimation result of the mental state in this case include information indicating the goodness/badness of mood, information indicating the degree of health, information indicating the degree of stress, information relating to the degree of anxiety, information relating to the degree of pleasantness, information relating to the degree of pleasure, information relating to the degree of interesting, information relating to the degree of satisfaction, information relating to the degree of activity, information relating to the pleasure-displeasure scale, information relating to the degree of comfort, and any combination thereof. Such information may be a binary index or may be a multiscale index. For example, the estimation result of the mental state is stored in the mental state storage unit 41 in association with the identification information of the target person who is a subject of the estimation and the date and time information corresponding to the estimated mental state.

The storage device 4 is not limited to the above-described example, and may store various kinds of information necessary for processing executed by the price determination device 1. For example, the storage device 4 may preliminarily store information on a mental state estimation model configured to estimate the mental state from the observation information. In this case, the mental state estimation model may be an expression for outputting the value of the index of the mental state when the observation information is inputted thereto, or may be a look-up table, or may be a learning model that is trained based on machine learning such as deep learning. For example, when the mental state estimation model is a learning model based on a neural network such as a convolutional neural network, the storage device 4 stores various parameter information regarding the layer structure, the neuron structure of each layer, the number of filters and the filter size in each layer, and the weight for each element of each filter.

The configuration of the price determination system 100 shown in FIG. 1 is an example, and various changes may be made to the configuration. For example, the input device 2 and the output device 3 may be configured integrally. In this case, the input device 2 and the output device 3 may be configured as a tablet-type terminal that is incorporated into or separate from the price determination device 1. Further, the input device 2 and the sensor 5 may be configured integrally. Further, the price determination device 1 may be configured by a plurality of devices. In this case, the plurality of devices constituting the price determination device 1 transmits and receives information necessary for executing the preassigned process among the plurality of devices. In this case, the price determination device 1 functions as a price determination system.

### (2) Hardware Configuration of Price Determination Device

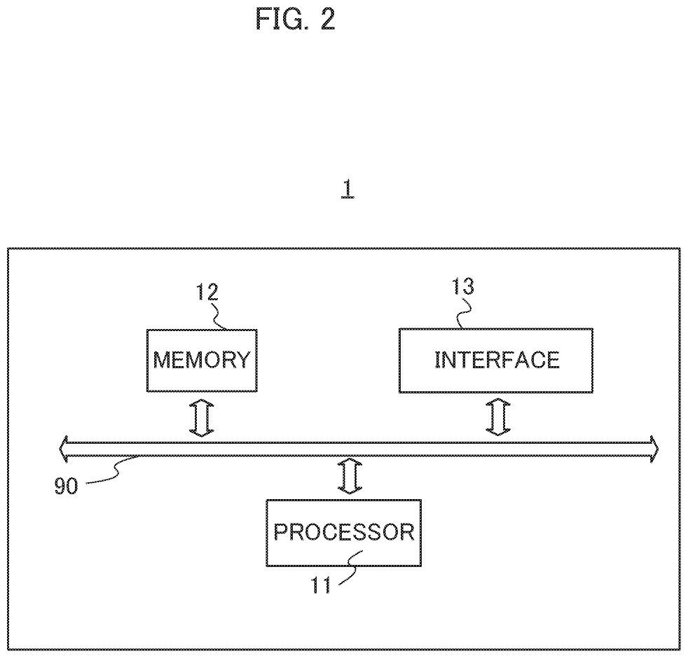

FIG. 2 shows a hardware configuration of the price determination device 1. The price determination device 1 includes a processor 11, a memory 12, and an interface 13 as hardware. The processor 11, memory 12 and interface 13 are connected to one another via a data bus 90.

The processor 11 functions as a controller (calculator) for controlling the entire price determination device 1 by executing a program stored in the memory 12. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by a variety of volatile and non-volatile memories, such as a RAM (Random Access Memory), a ROM (Read Only Memory), and a flash memory. Further, a program for executing the process performed by the price determination device 1 is stored in the memory 12. A part of the information stored in the memory 12 may be stored in one or more external storage devices (including the storage device 4) that can communicate with the price determination device 1, or may be stored in a removable storage medium detachable from the price determination device 1. The memory 12 may also alternatively store at least a portion of the information stored in the storage device 4.

The interface 13 is one or more interfaces for electrically connecting the price determination device 1 to other devices. Examples of these interfaces include a wireless interface, such as a network adapter, for transmitting and receiving data to and from other devices wirelessly, and a hardware interface, such as a cable, for connecting to other devices.

The hardware configuration of the price determination device 1 is not limited to the configuration shown in FIG. 2. For example, the price determination device 1 may include at least one of the input device 2 and/or the output device 3. Further, the price determination device 1 may be connected to or incorporate an audio output device such as a speaker.

### (3) Functional Blocks

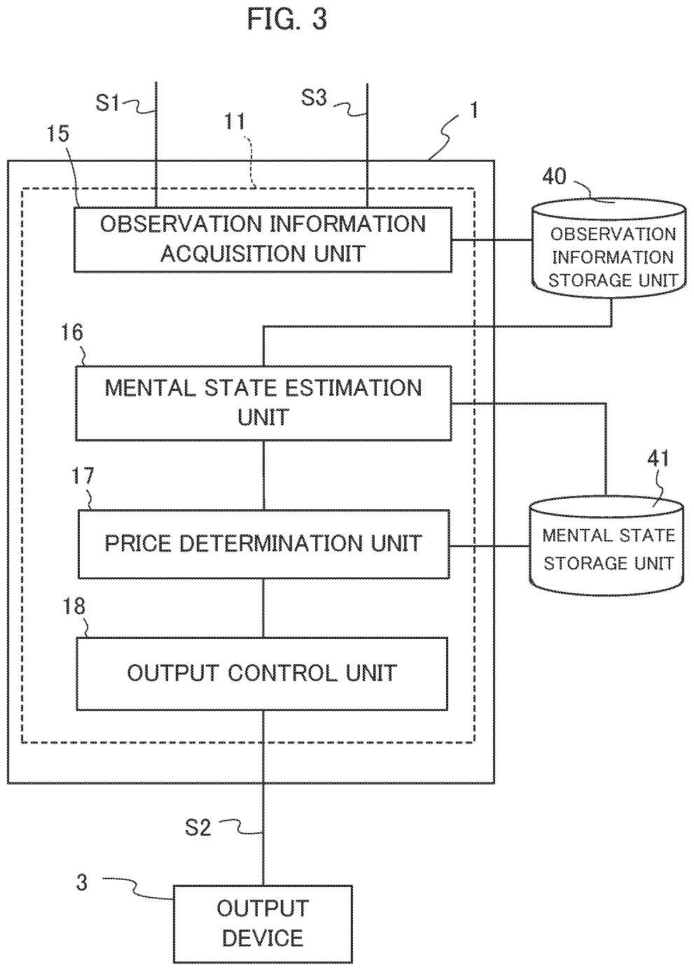

FIG. 3 is an example of a functional block of the price determination device 1. The price determination device 1 estimates the mental state of the target person who is provided (or was provided) with goods or a service and determines the price for the goods or the service based on an estimation result of the mental state. The processor 11 of the price determination device 1 functionally includes an observation information acquisition unit 15, a mental state estimation unit 16, a price determination unit 17, and an output control unit 18. In FIG. 3, any blocks to exchange data with each other are connected by a solid line, but the combination of blocks to exchange data with each other is not limited to the combination shown in FIG. 3. The same applies to other drawings of functional blocks described below

Based on the input signal S1 and the sensor signal S3, the observation information acquisition unit 15 acquires the observation information regarding the target person and stores the acquired observation information in the observation information storage unit 40. In this instance, as described above, the observation information acquisition unit 15 may acquire the sensor signal S3 as the observation information, or may acquire the features (including an index value representing the facial expression, emotion, and the like analyzed from an image or audio data) calculated based on the sensor signal S3 as the observation information. Further, the observation information acquisition unit 15 may acquire the questionnaire result information based on the input signal S1 or the diagnostic result regarding a personality or the like based on the questionnaire result information as the observation information.

The mental state estimation unit 16 estimates the mental state of the target person. In this case, based on the observation information regarding the target person stored in the observation information storage unit 40, the mental state estimation unit 16 estimates the mental state of the target person, and stores the estimation result of the mental state in the mental state storage unit 41. In this case, the mental state estimation unit 16 calculates a value of an arbitrary index of mental state such as a degree of mood, a degree of health, a degree of stress (a stress value), a degree of anxiety (an anxiety degree), a degree of pleasantness, a degree of pleasure, a degree of interesting, a degree of satisfaction (a satisfaction degree), a degree of activity (activity degree), a pleasure-displeasure scale (a pleasure degree), and a degree of comfort. Then, the mental state estimation unit 16 calculates the index value of the mental state by using the observation information having a correlation with the mental state to be estimated. In this case, for example, the mental state estimation unit 16 inputs the above-mentioned observation information to a mental state estimation model whose parameters are stored in advance in the storage device 4, and obtains the estimation result (i.e., an index value of the mental state) of the mental state outputted by the mental state estimation model in response to the input thereto.

For example, when calculating the stress value, the mental state estimation unit 16 extracts observation information regarding the target person indicating any information (e.g., heart rate, amount of perspiration, biological information such as skin temperature, facial expression and emotion information recognized from an image or voice, questionnaire results, personality diagnosis results, and operation logs) having a correlation with the stress from the observation information storage unit 40. Then, the mental state estimation unit 16 calculates the stress value of the target person from the extracted observation information. A method of estimating or predicting a degree of daily mood, health, or stress from an amount of perspiration, an acceleration, or the like is disclosed in Non-Patent Literature 1 to Non-Patent Literature 3, for example.

The price determination unit 17 determines the price relating to the goods or the service based on the estimation result of the mental state of the target person generated by the mental state estimation unit 16. In this case, the higher the degree of positiveness (positivity) of the mental state indicated by the estimation result of the mental state is, the higher price the price determination unit 17 sets. In this case, the price determination unit 17 may recognize the degree of positiveness from any index of the mental state described above. For example, as for such an index as the degree of mood, the degree of health, the satisfaction degree, the pleasure degree, the degree of comfort, and the like, the price determination unit 17 recognizes that the higher the value of the above-mentioned index is, the higher the degree of positiveness becomes. In contrast, as for such an index as the stress value and the degree of anxiety, the price determination unit 17 recognizes that the higher the value of the above-mentioned index is, the lower the degree of positiveness becomes. The price determination method by the price determination unit 17 will be described later. The price determination unit 17 supplies information regarding the determined price to the output control unit 18.

The output control unit 18 generates an output control signal S2 relating to the price determined by the price determination unit 17 and supplies the output control signal S2 to the output device 3 through the interface 13, thereby causing the output device 3 to output (display or output by audio) information relating to the price determined by the price determination unit 17. Instead of generating the output control signal S2, the output control unit 18 may store information regarding the price determined by the price determination unit 17 in the storage device 4 or the like, or may transmit the information to the accounting system or the like for settlement of the target goods or service.

Each component of the observation information acquisition unit 15, the mental state estimation unit 16, the price determination unit 17, and the output control unit 18 described in FIG. 3 can be realized by the processor 11 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

### (4) Price Determination Process

Next, a specific example of the price determination process corresponding to the process executed by the price determination unit 17 will be described. Examples of models of the price determination process include “fund splitting model”, “whole consensus based price variation model”, and “individual agreement based price variation model”.

The “fund splitting model” is a price determination mode to determine the amount of remuneration (remuneration price) to each remuneration recipient based on the mental state of the target person who buys a service offered by remuneration recipients, when a fund of the remuneration is distributed to multiple remuneration recipients. The “whole consensus based price variation model” is a price determination mode to determine a uniform price of goods or a service based on the mental states of plural target persons who buy the goods or the service. The “individual agreement based price variation model” is a price determination mode to individually determine the price of goods or a service to be paid by a target person who buys the goods or the service, based on the mental state of the target person. The “whole consensus based price variation model” and the “individual agreement based price variation model” are common in that the price, to be paid by the target person, for the goods or the service provided (or supposed to be provided) to the target person is determined based on the mental state of the target person.

### (4-a) Fund Splitting Model

According to the “fund splitting model”, the price determination device 1 determines the amount of remuneration to each remuneration recipient based on the mental state of the target person who buys the service offered by remuneration recipients, in the case where the fund of the remuneration is distributed to multiple remuneration recipients. The price determination method according to the “fund splitting model” is suitably applied to the price determination of commodities or services paid according to a deferred payment system.

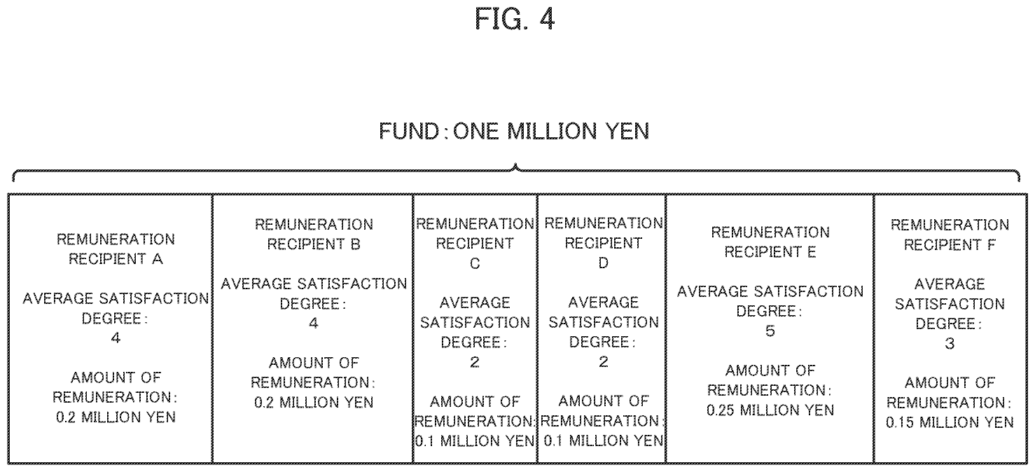

FIG. 4 is a diagram showing an outline of the price determination method according to the “fund splitting model”. Specifically, FIG. 4 shows the average satisfaction degree and the amount of remuneration from target persons to each remuneration recipient in the case where one million yen as a fund is distributed to the remuneration recipients A to F. Here, the “average satisfaction degree” indicates the average value of the satisfaction degree based on the mental states of the target persons who were provided with the service immediately after or in the middle of the service in which the remuneration recipients A to F took part.

In this case, for example, the price determination device 1 estimates, as the mental state, the satisfaction degree representing the degree of satisfaction of each target person who has received the service from the remuneration recipients, and aggregates, for each remuneration recipient, the satisfaction degrees of the target persons who received the service from each remuneration recipient. Here, the price determination device 1 calculates the average value (average satisfaction degree) of the satisfaction of the target person for each remuneration recipient as the aggregation result. Then, the price determination device 1 increases the amount of remuneration of a remuneration recipient with increase in the average satisfaction degree for the remuneration recipient. Here, as an example, the price determination device 1 determines the amount of remuneration of the remuneration recipient to be proportional to the average satisfaction degree. Specifically, the price determination device 1 determines the amount of remuneration of a remuneration recipient to be a price obtained by multiplying 50000 yen by the average satisfaction degree for the remuneration recipient, wherein the above-mentioned 50000 yen is obtained by dividing one million yen that is the fund by the total value “20” (=4+4+2+2+5+3) of the average satisfaction degrees.

The calculation method of the amount of remuneration is not limited to the example shown in FIG. 4. For example, the price determination device 1 may determine the amount of remuneration based on, instead of using the average satisfaction degree, the aggregation result of aggregating the count of the satisfaction degrees for each level. For example, it is herein assumed that for one million yen that is the fund, “0.4 million yen” is assigned to the satisfaction degree “5”, “0.3 million yen” is assigned to the satisfaction degree “4”, “0.2 million yen” is assigned to the satisfaction degree “3”, and “0.1 million yen” is assigned to the satisfaction degree “2” and that target persons include 20 people with the satisfaction degrees “2” to “5”. In this case, providing that a remuneration recipient A gets the satisfaction degree “5” from four people, the satisfaction degree “4” from eight people, the satisfaction degree “3” from four people, the amount of remuneration to be earned by the remuneration recipient A is as follows:

0.4 million yen×(4/20)+0.3 million yen×(8/20)+0.2 million yen×(4/20)=0.24 million yen

The amounts of remuneration of other remuneration recipients are also determined based on the same calculation procedure as mentioned above.

Thus, in the price determination method according to the “fund splitting model”, the price determination device 1 determines the amount of remuneration to a remuneration recipient who receives a distribution of remuneration for the service provided to the target persons, based on the mental state of the target persons who received the service from the remuneration recipient. More specifically, the price determination device 1 acquires estimation results of the mental states of the target persons, who are provided with the service from the plurality of remuneration recipients, aggregates the estimation results of the mental states with respect to each of the remuneration recipients, and determines the amount of remuneration to each of the remuneration recipients based on the aggregation result. Thus, the price determination device 1 can appropriately determine the amount of remuneration to a remuneration recipient who receives the distribution of the remuneration relating to the service in accordance with the satisfaction degree of the target persons who are provided with the service from the remuneration recipient.

Here, as a specific example of the fund splitting model, a description will be given of the case where remuneration recipients are performers such as a street performer. In this case, the price determination device 1 estimates the satisfaction degree of each target person by, for example, analyzing the facial expression of each target person from an image of each target person (in this case, audience) taken by the camera installed in performance place(s) of the remuneration recipients. In this case, for example, the remuneration recipients may perform the performance at different time slots in the same venue, or may perform at the same or different time slot in different venues. In the former case, the price determination device 1 estimates the mental states of people in the audience in the performance time slot of each remuneration recipient based on images generated by camera(s) which photograph the people in the audience provided in the venue. In the latter case, the price determination device 1 estimates the mental states of people in the audience at the performance time slot of each remuneration recipient based on images generated by camera(s) that photograph the audience provided in the performance venue of each remuneration recipient. In this case, each person (i.e., target person) in the audience may watch the performance of all remuneration recipients or the performance of a part of the remuneration recipients.

The price determination device 1 may estimate the satisfaction degree of each person in the audience based on the voice data obtained from a microphone instead of a camera, or may estimate the satisfaction degree of each person in the audience based on the biological information (including the acceleration) obtained from a wearable terminal mounted on each person in the audience. Further, the price determination device 1 may calculate any index of the mental state other than the satisfaction degree, such as a stress value, a degree of pleasantness, an activity degree, and a comfort degree,

The application examples of the fund splitting model is not limited to cases where the remuneration receivers are performers such as a street performer. For example, in a company with more than one employee, when a fund of lump-sum payments such as bonuses is fixed and the fund is supposed to be distributed to plural employees, the price determination device 1 may determine the lump-sum payment of each employee based on the estimation result of the mental state estimated from customer(s) taken care of by the each employee. In this case, for example, the price determination device 1 calculates the average satisfaction degree of the customers for each employee in the same way as the example shown in FIG. 4. Then, the price determination device 1 increases the lump-sum payment of an employee with increase in the average satisfaction degree for the employee. Thus, the price determination device 1 can appropriately and fairly determine the amount of the lump-sum payment of each employee in accordance with the customer satisfaction degree.

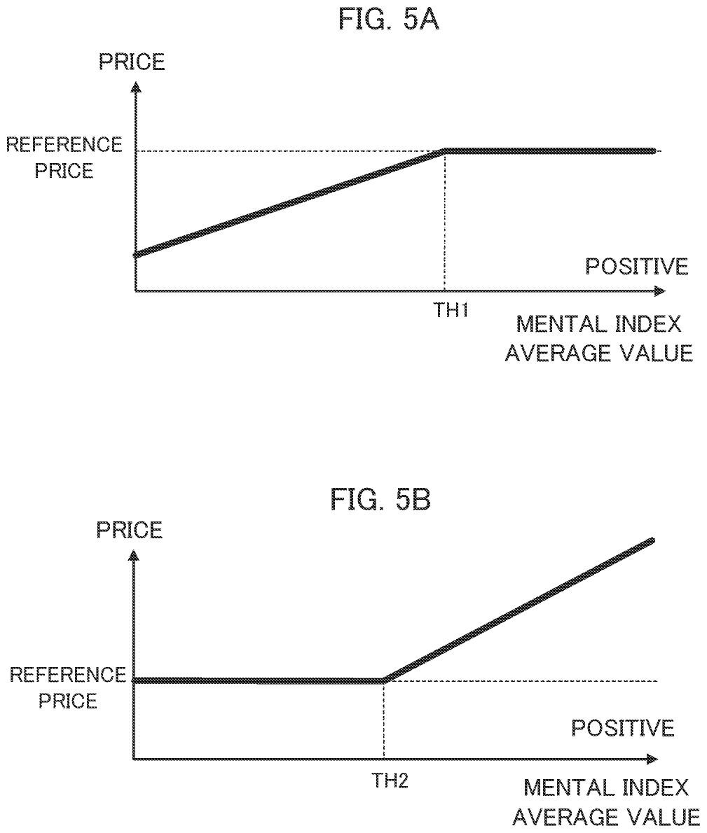

(4-b) Whole Consensus Based Price Variation Model According to the “whole consensus based price variation model”, the price determination device 1 determines a uniform price for goods or a service based on the mental states of the target persons who are provided with the goods or the service in common. FIG. 5A shows the transition of the price in the first mode of the “whole consensus based price variation model”, and FIG. 5B shows the transition of the price in the second mode of the “whole consensus based price variation model”.

According to the first mode shown in FIG. 5A, the larger the average value (referred to as “mental index average value”) of the index of the mental states of the target persons who bought a target goods or service is, the closer price (value) to a reference price that is a normal (standard) price for the target goods or service the price determination device 1 sets. Here, it is assumed that the larger the index value of a mental state is, the larger the positiveness of the mental state becomes. The index of the mental state may be any index representing, for example, the satisfaction degree, the pleasure/displeasure scale, the degree of comfort, the degree of interesting, the degree of pleasure, and the degree of goodness/badness of mood.

Then, in the first mode, if the mental index average value is equal to or larger than a predetermined threshold value “TH1”, the price determination device 1 sets the price (value) for the target goods or service to the reference price. Thus, in the first mode, the reference price is provided as the highest (upper limit) price for the target goods or service. In other words, in the first mode, if the mental index average value of the target persons who bought the target goods or service is smaller than the predetermined threshold value TH1, the price determination device 1 sets the price for the target goods or service to a price lower than the reference price. Then, if the mental index average value is less than the threshold value TH1, the price determination device 1 decreases the price for the target goods or service with decrease in the mental index average value.

On the other hand, in the second mode shown in FIG. 5B, the reference price is provided as the lowest price (lower limit) for the target goods or service, and the price determination device 1 sets the price (value) for the target goods or service to a price larger than the reference price if the mental index average value is equal to or larger than a threshold value “TH2”. Then, if the mental index average value is equal to or larger than the threshold value TH2, the price determination device 1 increases the price (value) for the target goods or service with increase in the mental index average value.

The price determination method according to the “whole consensus based price variation model” is suitably used, for example, for the price setting in the initial stage when a service is started to be offered. In this case, for example, it is suitably applied to such a service operation in which a user starts to use the service with a comparatively reasonable price and then the price becomes close to the normal price as the satisfaction degree of the whole target persons increases. In addition, the price determination method according to the “whole consensus based price variation model” is also suitably used for the due diligence of a venture capital. For example, when a start-up company gives a presentation in front of multiple investors, the price determination device 1 determines the investment price for the start-up company that gave the presentation based on the estimated results of the mental states of these investors.

The price determination device 1 may determine the price for the target goods or service without calculating the mental index average value. For example, in this case, in some embodiments, instead of the example shown in FIG. 5A, the price determination device 1 sets the price for the target goods or service to the reference price if the target persons whose index value of the mental state is equal to or larger than the threshold value TH1 become a majority. In contrast, if the target persons whose index value of the mental state is equal to or larger than the threshold value TH1 are not a majority, the price determination device 1 sets the price for the target goods or service to be lower than the reference price. Similarly, instead of the example shown in FIG. 5B, in some embodiments, the price determination device 1 sets the price for the target goods or service to be the reference price if the target persons whose index value of the mental state is smaller than the threshold value TH2 become a majority. In contrast, if the target persons whose index value of the mental state is smaller than the threshold value TH2 are not a majority, the price determination device 1 sets the price for the target goods or service to be higher than the reference price. In another example, the price determination device 1 may aggregate the index values of the mental states for each level, and determine the price for the target goods or service based on the aggregated result. In this case, with reference to a predetermined equation or look-up table, the price determination device 1 determines the price of the target goods or service based on the percentages of respective levels of the index values of the mental states.

In some embodiments, the price determination device 1 may not provide a threshold value relating to the index value of the mental state for determining an upper limit or a lower limit of the price of the target goods or a service. In this case, for example, with reference to a predetermined equation or look-up table indicating a positive correlation between the mental index average value and the price, the price determination device 1 determines the price for the target goods or service from the mental index average value.

In some embodiments, in the case of a business form having a plurality of stores, the price determination device 1 may determine the price for each store based on the estimation results of the mental states of the customers (target persons) for each store. In this case, based on the estimation results of the mental states in each store in a month, the price determination device 1 determines the price (e.g., tip, service fee, or an additional amount from a base price) to be used in the each store in the subsequent month. In this case, for example, the price determination device 1 increases the price to be set in each store in the subsequent month with increase in the mental index average value of the customers in the each store in a month.

As described above, in the price determination method according to “whole consensus based price variation model”, the price determination device 1 determines the price for goods or a service based on the mental states of a plurality of target persons provided with the goods or the service. Therefore, the price determination method according to “whole consensus based price variation model” is preferably applied to the price determination of commodities or services paid according to a deferred payment system.

### (4-c) Individual Agreement Based Price Variation Model

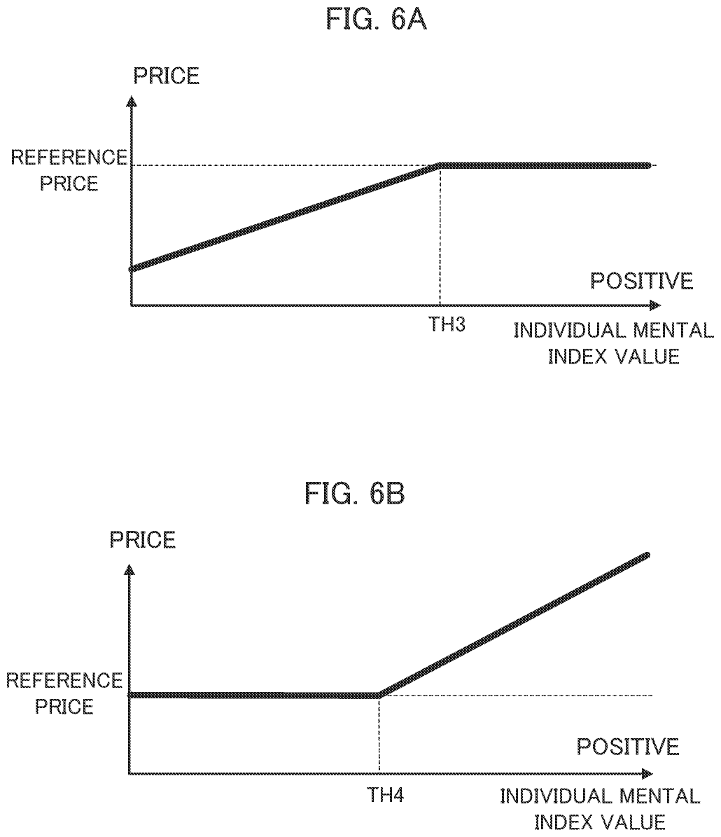

According to the “individual agreement based price variation model”, the price determination device 1 determines the price for goods or a service individually for each target person based on an estimation result of the mental state of each target person who is or was provide with the goods or the service. FIG. 6A shows the transition of the price in the first mode of the “individual agreement based price variation model”, and FIG. 6B shows the transition of the price in the second mode of the “individual agreement based price variation model”.

In the first mode shown in FIG. 6A, the price determination device 1 determines the price for the target goods or service to be paid by a target person so that the larger the value of the index (referred to as “individual mental index”) regarding the individual mental state of the target person, the closer price (value) to the reference price that is the normal price (standard price) is set. The price determination device 1 sets the price (value) to be paid by the target person for the target goods or service to be the reference price if the value of the individual mental index is equal to or larger than a predetermined threshold value “TH3”. The individual mental index may be any index representing, for example, the satisfaction degree, the degree of pleasantness, the degree of comfort, the degree of interesting, the degree of pleasure, or the degree of goodness/badness of mood.

In the second mode shown in FIG. 6B, the reference price is the lowest price for the target goods or service, and the price determination device 1 sets the price (value) to be paid by the target person for the target goods or service to a price higher than the reference price if the value of the individual mental index becomes larger than a threshold value “TH4”. Then, when the value of the individual mental index becomes larger than the threshold value TH4, the price determination device 1 increases the price (value) to be paid by the target person for the target goods or service with increase in the value of the individual mental index.

In some embodiments, the price determination device 1 may calculate the price based on a comparison result between the individual mental index and an index (also referred to as “population mental index”) of the mental states of people that are a population who buy or bought the same goods or service. In this case, the price determination device 1 increases the price to be paid by the target person for goods or a service with increase in the individual mental index relative to the population mental index. In this case, for example, if the value of the individual mental index is higher than the value of the population mental index by a predetermined threshold value or more, the price determination device 1 sets the price to be a predetermined amount larger than the reference value. In contrast, if the value of the individual mental index is lower than the value of the population mental index by a predetermined threshold value or more, the price determination device 1 sets the price to be a predetermined amount smaller than the reference value. In another example, the price determination device 1 determines the price (value) to be paid by the target person for goods or service, based on the ratio or difference between value of the individual mental index and the value of the population mental index, with reference to a predetermined formula or look-up table.

The above-mentioned “individual agreement based price variation model” is suitably applied to a flea market site where price negotiation is possible, for example. In this case, the price determination device 1 determines the price for the goods or service in consideration of the mental state of a customer in addition to the price desired by a seller or the customer. In this case, for example, the price determination device 1 increases the reduction amount from the normal price with increase in the negativity of the mental state of the customer. In another example, the price determination device 1 may determine the amount of tip in a hotel or a restaurant or the nomination fee for a lecturer, a coach, or a hairdresser, based on the estimation result of the mental state of the target customer. In this case, the price determination device 1 increases the amount of the above-described tip or nomination fee with increase in the positiveness of the mental state of the target customer.

The above-mentioned “individual agreement based price variation model” is also suitably used for determining the price of goods or a service to be provided to a customer who stands in line to buy the goods or the service. In this case, the price determination device 1 calculates the value of the individual mental index based on a facial expression or the like of each customer recognized from an image or the like obtained by photographing each customer which stands in line for the store, and determines the price to be paid by each customer for the goods or the service based on the value of the individual mental index. In this case, for example, the price determination device 1 decreases the price to be paid by a customer for the goods or the service provided in the store with decrease (i.e., increasing mental negativity) in the value of the individual mental index of the customer. Thus, the price determination device 1 can set the price so as to suitably alleviate the dissatisfaction of the customers standing in line in order to buy goods or a service. Therefore, in this mode, it is expected that there will be a decrease in complaints from customers who become a bad mood by standing in line.

In addition, even in the price determination which does not fall under any of “fund splitting model”, “whole consensus based price variation model”, and “individual agreement based price variation model”, the price determination device 1 may determine the price for an offered or offering goods or service, based on the estimation result of the mental state of the target person.

### (5) Processing Flow

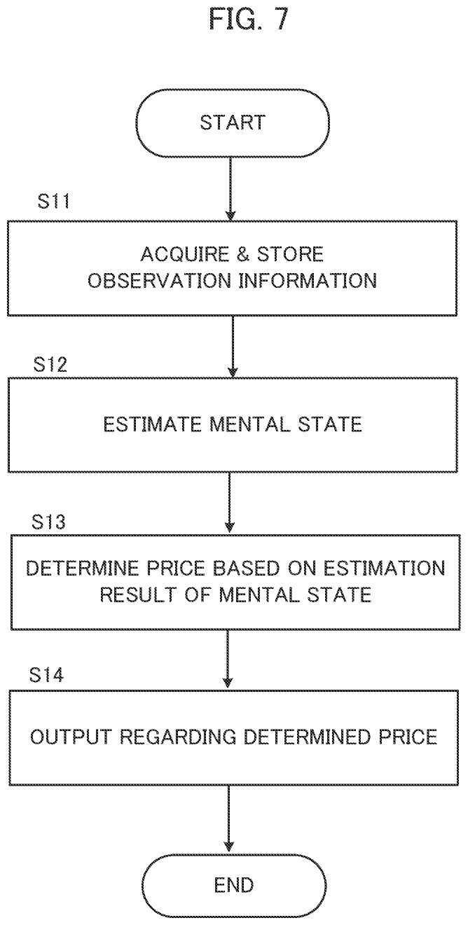

FIG. 7 is an example of a flowchart that is executed by the price determination device 1 in the first example embodiment.

First, the price determination device 1 acquires observation information regarding a person who is provided with goods or a service (including the person in the middle of receiving the service or immediately after receiving the service) on the basis of the input signal S1 supplied from the input device 2 and/or the sensor signal S3 supplied from the sensor 5, and stores the acquired observation information in the observation information storage unit 40 (step S11).

Then, based on the observation information acquired at step S11, the price determination device 1 estimates the mental state of the person who is observed to acquire the observation information (step S12). In this case, for example, the price determination device 1 uses any mental state estimation model (including a calculation formula and a look-up table) stored in the storage device 4 or the like to calculate an index value representing the mental state from the observation information.

Then, the price determination device 1 determines the price based on the estimation result of the mental state estimated at step S12 (step S13). In this instance, the price determination device 1 determines the price for the goods or the service which the person whose mental state is estimated at step S12 receives (or received).

Then, the price determination device 1 output information regarding the determined price (step S14). In this instance, the price determination device 1 may output (display or output by audio) information regarding the price determined at step S13 by the output device 3, or may transmit information regarding the price to an accounting system or the like that performs payment of the goods or the service.

### Second Example Embodiment

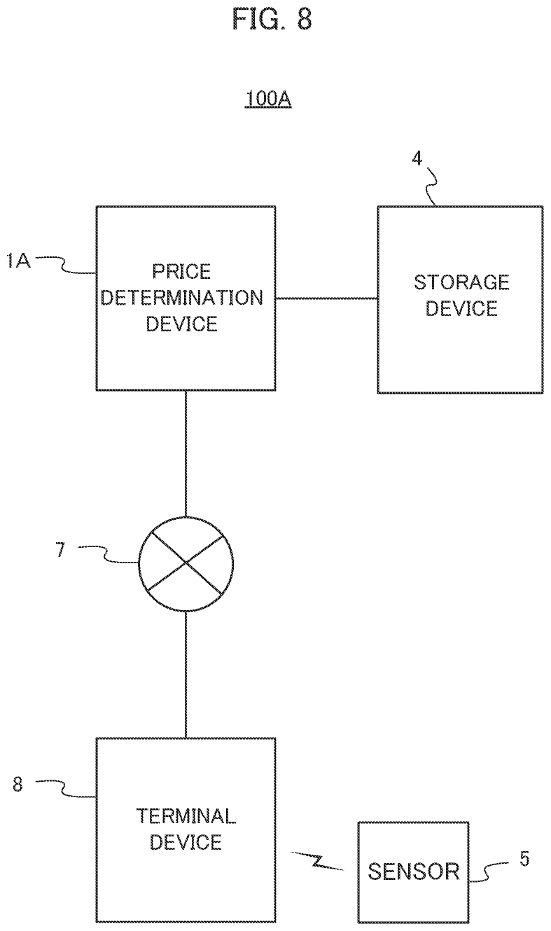

FIG. 8 shows a schematic configuration of a price determination system 100A according to the second example embodiment. The price determination system 100A according to the second example embodiment is a system according to a server-client model, and a price determination device 1A functioning as a server device performs a process of the price determination device 1 according to the first example embodiment. Hereinafter, the same components as in the first example embodiment are appropriately denoted by the same reference numerals, and a description thereof will be omitted.

As shown in FIG. 8, the price determination system 100A mainly includes a price determination device 1A that functions as a server, a storage device 4, and a terminal device 8 that functions as a client. The price determination device 1A and the terminal device 8 perform data communication via the network 7 with each other.

The terminal device 8 is a terminal used by a person (user) who is provided with goods or a service through an electronic commerce to buy goods or a service, and it includes an input function, a display function, and a communication function. Therefore, the terminal device 8 functions as the input device 2 and the output device 3 shown in FIG. 1. Examples of the terminal device 8 include a personal computer, a tablet-type terminal such as a smartphone, and a PDA (Personal Digital Assistant). The terminal device 8 is electrically connected to a sensor 5 such as a wearable sensor worn by a user, and transmits a biological signal or the like (i.e., information corresponding to the sensor signal S3 in FIG. 1) regarding the person outputted by the sensor 5 to the price determination device 1A. In addition, the terminal device 8 receives the user input or the like relating to the answer of a questionnaire and transmits the information (information corresponding to the input signal S1 in FIG. 1) generated by the user input to the price determination device 1A.

The price determination device 1A is equipped with a hardware configuration identical to the hardware configuration of the price determination device 1 shown in FIG. 2, and the processor 11 of the price determination device 1A is equipped with the functional blocks shown in FIG. 3. Then, the price determination device 1A receives the information corresponding to the input signal S1 and the sensor signal S3 in FIG. 1 from the terminal device 8 via the network 7, and executes the price determination process. The price determination device 1A transmits an output signal for outputting information regarding the determined price or the like to the terminal device 8 via the network 7.

According to the second example embodiment, it is possible to suitably determine the price for goods or a service provided to a user in accordance with the mental state of the user, based on the biological signal or the like regarding the user supplied from the terminal used by the user.

### Third Example Embodiment

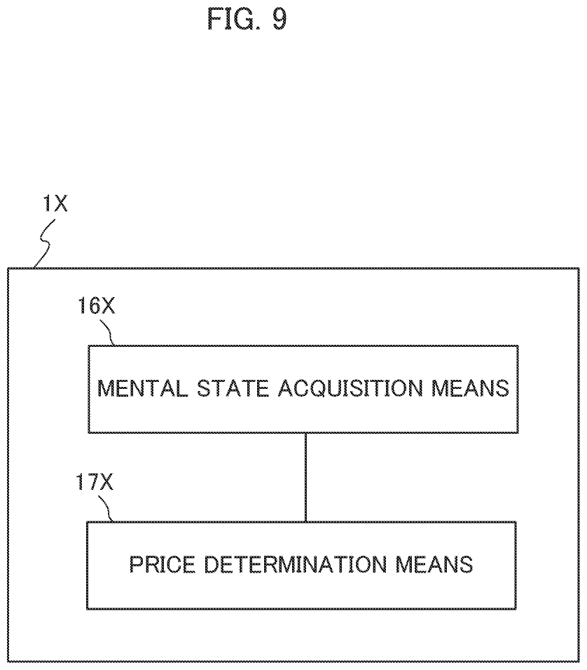

FIG. 9 is a block diagram of the price determination device 1X according to the third example embodiment. The price determination device 1X mainly includes a mental state acquisition means 16X and a price determination means 17X. The price determination device 1X may be configured by a plurality of devices.

The mental state acquisition means 16X is configured to acquire an estimation result of a mental state of a target person. In this instance, the mental state acquisition means 16X may acquire the estimation result of the mental state by estimating the mental state from a biological signal or the like of the target person, or may acquire the estimation result of the mental state stored in a storage device or estimated by any other device. Examples of the mental state acquisition means 16X in the former case include the mental state estimation unit 16 in the first example embodiment (including modifications, hereinafter the same) or the second example embodiment.

The price determination means 17X is configured to determine a price for goods or a service provided to the target person, based on the estimation result of the mental state. Examples of the price determination means 17X include the price determination unit 17 in the first example embodiment or the second example embodiment.

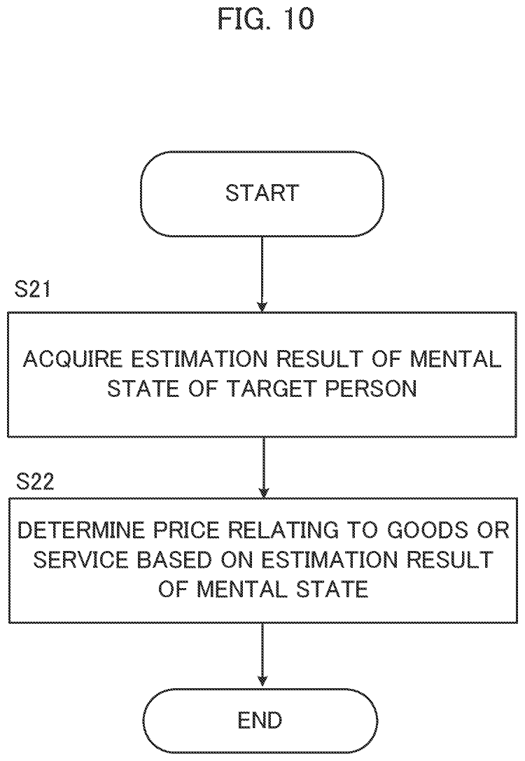

FIG. 10 is an exemplary flowchart executed by the price determination device 1X in the third example embodiment. First, the mental state acquisition means 16X acquires an estimation result of a mental state of a target person (step S21). Then, the price determination means 17X determines a price for goods or a service provided to the target person, based on the estimation result of the mental state (step S22).

According to the third example embodiment, the price determination device 1X can suitably determine the price relating goods or the service provided to a target person to be an appropriate price for the target person based on the estimation result of the mental state of the target person.

In the example embodiments described above, the program is stored by any type of anon-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or apart of the example embodiments (including modifications, the same shall apply hereinafter) described above can be described as, but not limited to, the following Supplementary Notes.

### Supplementary Note 1

A price determination device comprising:
a mental state acquisition means configured to acquire an estimation result of a mental state of a target person; and
a price determination means configured to determine a price for goods or a service provided to the target person, based on the estimation result of the mental state.

### Supplementary Note 2

The price determination device according to Supplementary Note 1,
wherein the price determination means is configured to determine, based on the estimation result of the mental state, the price that is an amount of remuneration to a remuneration recipient for the service provided to the target person.

### Supplementary Note 3

The price determination device according to Supplementary Note 2,
wherein, in a case where a fund is distributed as the remuneration to plural remuneration recipients, the mental state acquisition means is configured to acquire estimation results of mental states of target persons to which services from the plural remuneration recipients are provided, and wherein the price determination means is configured to aggregate the estimation results of the mental states with respect to each of the plural remuneration and determine the amount of the remuneration to each of the plural remuneration based on a result of the aggregation.

### Supplementary Note 4

The price determination device according to Supplementary Note 1,
wherein the price determination means is configured to determine the price that is an amount of payment to be paid by the target person for the goods or the service.

### Supplementary Note 5

The price determination device according to Supplementary Note 4,
wherein the mental state acquisition means is configured to acquire estimation results of mental states of plural target persons, and
wherein the price determination means is configured to determine, based on the estimation results of the mental states, the price that is a uniform price for the goods or the service provided to the plural target persons in common.

### Supplementary Note 6

The price determination device according to Supplementary Note 4,
wherein the mental state acquisition means is configured to acquire estimation results of mental states of plural target persons, and
wherein the price determination means is configured to determine, based on the estimation results of the mental states, the price individually for each of the plural target persons for the goods or the service provided to the plural target persons in common.

### Supplementary Note 7

The price determination device according to Supplementary Note 4 or 6,
wherein the target person is a customer which stands in line for a store,
wherein the mental state acquisition means is configured to acquire an estimation result of a mental state of the customer, and
wherein the price determination means is configured to determine the price to be paid by the customer in the store, based on the estimation result of the mental state.

### Supplementary Note 8

The price determination device according to any one of Supplementary Notes 1 to 7,
wherein the price determination means is configured to increase the price with increase in the degree of positiveness of the mental state indicated by the estimation result of the mental state.

### Supplementary Note 9

The price determination device according to Supplementary Note 8,
wherein the price determination means is configured to set at least one of an upper limit and/or a lower limit of the price.

### Supplementary Note 10

A price determination device comprising:
a mental state acquisition means configured to acquire estimation results of mental states of plural target person; and
a price determination means configured to determine a price for goods or a service provided to the plural target persons, based on the estimation results of the mental states.

### Supplementary Note 11

A price determination method executed by a computer, the price determination method comprising:
acquiring an estimation result of a mental state of a target person; and
determining a price for goods or a service provided to the target person, based on the estimation result of the mental state.

### Supplementary Note 12

A storage medium storing a program executed by a computer, the program causing the computer to
acquire an estimation result of a mental state of a target person; and
determine a price for goods or a service provided to the target person, based on the estimation result of the mental state.

### Supplementary Note 13

A price determination method executed by a computer, the price determination method comprising:
acquiring estimation results of mental states of plural target person; and
determining a price for goods or a service provided to the plural target persons, based on the estimation results of the mental states.

### Supplementary Note 14

A storage medium storing a program executed by a computer, the program causing the computer to
acquire estimation results of mental states of plural target person; and
determine a price for goods or a service provided to the plural target persons, based on the estimation results of the mental states.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, TA, 1X Price determination device
2 Input device
3 Output device
4 Storage device
5 Sensor
8 Terminal device
100, 100A Price determination system

What is claimed is:

1. A value determination device based on user mental state comprising:
at least one memory configured to store instructions; and
at least one processor configured to execute the instructions to:
acquire a sensor signal from a biological signal measurement sensor which measures a target person;
calculate a feature from the sensor signal;
estimate a mental state of the target person using a machine learned model, based on observation data regarding the target person including the sensor signal;
acquire an estimation result of the mental state of the target person; and
determine a value for goods or a service provided to the target person, based on the estimation result of the mental state,
wherein, in a case where a fund is distributed as remuneration to plural remuneration recipients, the at least one processor is configured to execute the instructions to acquire estimation results of mental states of target persons to which services from the plural remuneration recipients are provided, and
wherein the at least one processor is configured to execute the instructions to aggregate the estimation results of the mental states with respect to each of the plural remuneration and determine the amount of the remuneration to each of the plural remuneration based on a result of the aggregation.

2. (canceled)

3. (canceled)

4. The value determination device based on user mental state according to claim 1,
wherein the at least one processor is configured to execute the instructions to determine the value that is an amount of payment to be paid by the target person for the goods or the service.

5. The value determination device based on user mental state according to claim 4,
wherein the at least one processor is configured to execute the instructions to acquire estimation results of mental states of plural target persons, and
wherein the at least one processor is configured to execute the instructions to determine, based on the estimation results of the mental states, the value that is a uniform value for the goods or the service provided to the plural target persons in common.

6. The value determination device based on user mental state according to claim 4,
wherein the at least one processor is configured to execute the instructions to acquire estimation results of mental states of plural target persons, and
wherein the at least one processor is configured to execute the instructions to determine, based on the estimation results of the mental states, the value individually for each of the plural target persons for the goods or the service provided to the plural target persons in common.

7. The value determination device based on user mental state according to claim 4,
wherein the target person is a customer which stands in line for a store,
wherein the at least one processor is configured to execute the instructions to acquire an estimation result of a mental state of the customer, and
wherein the at least one processor is configured to execute the instructions to determine the value to be paid by the customer in the store, based on the estimation result of the mental state.

8. The value determination device based on user mental state according to claim 1,
wherein the at least one processor is configured to execute the instructions to increase the value with increase in the degree of positiveness of the mental state indicated by the estimation result of the mental state.

9. The value determination device based on user mental state according to claim 8,
wherein the at least one processor is configured to execute the instructions to set at least one of an upper limit and/or a lower limit of the value.

10. A value determination device based on user mental state comprising:
at least one memory configured to store instructions; and
at least one processor configured to execute the instructions to:
acquire a sensor signal from a biological signal measurement sensor which measures a target person;
calculate a feature from the sensor signal;
estimate a mental state of the target person using a machine learned model, based on observation data regarding the target person including the sensor signal;
acquire estimation results of mental states of plural target person; and
determine a value for goods or a service provided to the plural target persons, based on the estimation results of the mental states;
wherein, in a case where a fund is distributed as remuneration to plural remuneration recipients, the at least one processor is configured to execute the instructions to acquire estimation results of mental states of target persons to which services from the plural remuneration recipients are provided, and
wherein the at least one processor is configured to execute the instructions to aggregate the estimation results of the mental states with respect to each of the plural remuneration and determine the amount of the remuneration to each of the plural remuneration based on a result of the aggregation.

11. A value determination method based on user mental state executed by a computer, the value determination method comprising:
acquiring a sensor signal from a biological signal measurement sensor which measures a target person;
calculating a feature from the sensor signal;
estimating a mental state of the target person using a machine learned model, based on observation data regarding the target person including the sensor signal;
acquiring an estimation result of the mental state of the target person; and
determining a value for goods or a service provided to the target person, based on the estimation result of the mental state, and
in a case where a fund is distributed as remuneration to plural remuneration recipients, acquiring estimation results of mental states of target persons to which services from the plural remuneration recipients are provided, and
aggregating the estimation results of the mental states with respect to each of the plural remuneration and determine the amount of the remuneration to each of the plural remuneration based on a result of the aggregation.

12. A non-transitory computer readable storage medium storing a program executed by a computer, the program causing the computer to:
acquire a sensor signal from a biological signal measurement sensor which measures a target person;
calculate a feature from the sensor signal;
estimate a mental state of the target person using a machine learned model, based on observation data regarding the target person including the sensor signal;
acquire an estimation result of a mental state of a target person; and
determine a value for goods or a service provided to the target person, based on the estimation result of the mental state, and
in a case where a fund is distributed as remuneration to plural remuneration recipients, acquire estimation results of mental states of target persons to which services from the plural remuneration recipients are provided, and
aggregate the estimation results of the mental states with respect to each of the plural remuneration and determine the amount of the remuneration to each of the plural remuneration based on a result of the aggregation.

13. A value determination method based on user mental state executed by a computer, the value determination method comprising:
acquiring a sensor signal from a biological signal measurement sensor which measures a target person;
calculating a feature from the sensor signal;
estimating a mental state of the target person using a machine learned model, based on observation data regarding the target person including the sensor signal;
acquiring estimation results of mental states of plural target person; and
determining a value for goods or a service provided to the plural target persons, based on the estimation results of the mental states, and
in a case where a fund is distributed as remuneration to plural remuneration recipients, acquiring estimation results of mental states of target persons to which services from the plural remuneration recipients are provided, and
aggregating the estimation results of the mental states with respect to each of the plural remuneration and determine the amount of the remuneration to each of the plural remuneration based on a result of the aggregation.

14. A non-transitory computer readable storage medium storing a program executed by a computer, the program causing the computer to:
acquire estimation results of mental states of plural target person; and
determine a value for goods or a service provided to the plural target persons, based on the estimation results of the mental states, and
in a case where a fund is distributed as remuneration to plural remuneration recipients, acquire estimation results of mental states of target persons to which services from the plural remuneration recipients are provided, and
aggregate the estimation results of the mental states with respect to each of the plural remuneration and determine the amount of the remuneration to each of the plural remuneration based on a result of the aggregation.
